(19) United States
(12) Patent Application Publication
(10) Pub. No.: US 2005/0173979 A1
(43) Pub. Date: Aug. 11, 2005

(54) Electomagnetic valve, especially for slip regulated motor vehicle brake systems

(76) Inventor: Christoph Voss, Frankfurt am Main (DE)

Correspondence Address: RATNERPRESTIA, P O BOX 980, VALLEY FORGE, PA, 19482-0980, US

(21) Appl. No.: 10/511,010

(22) PCT Filed: Apr. 22, 2003
(86) PCT No.: PCT/EP03/04169

(30) Foreign Application Priority Data
Apr. 28, 2002 (DE) 102 18 658.8

(51) Int. Cl. B60T 8/36

(52) U.S. Cl. 303/119.2

(57) ABSTRACT

The present invention relates to an electromagnetic valve, the spring thereof being arranged outside the flow route that can connect the pressure fluid inlet to the pressure fluid outlet in order to reduce the flow resistance, to what end a stop is inserted in the valve housing remote from the flow route, on which stop the end of spring facing away from the second valve closure member rests.

### DETAILED DESCRIPTION OF THE PREFERRED EMBODIMENTS

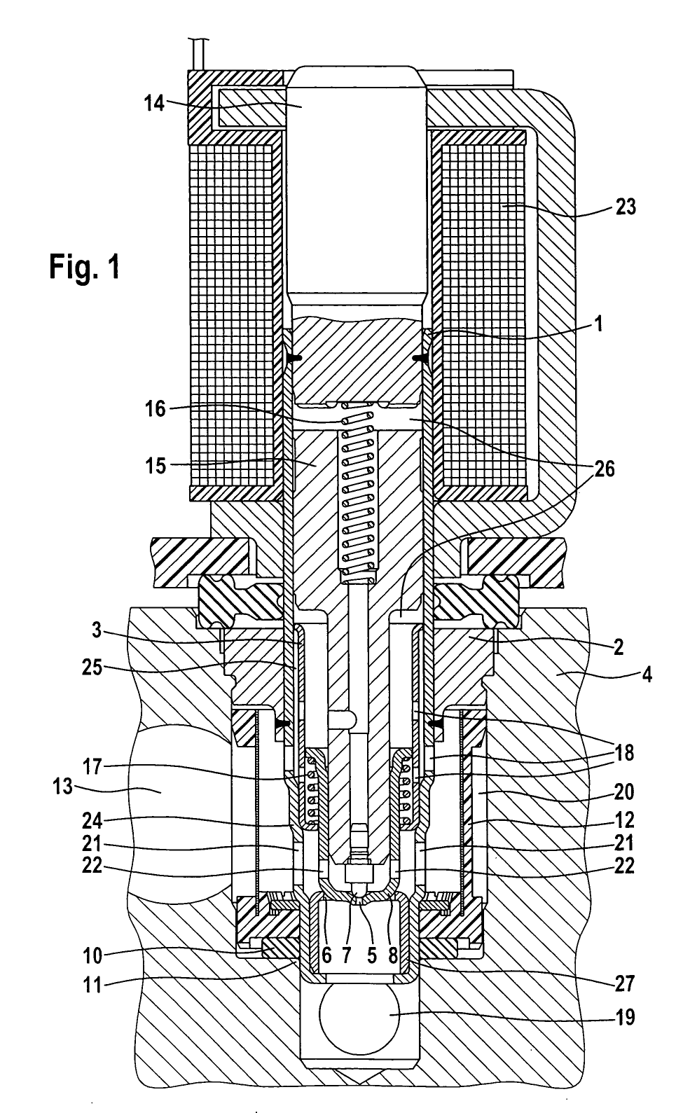

FIG. 1 shows a considerably enlarged longitudinal cross-sectional view of an electromagnetic valve including a one-part deepdrawn valve housing 1 of thin-walled design that accommodates a separate retaining collar 2 seated on the outside periphery of the valve housing and attached by means of laser welding, said retaining collar being made by non-cutting shaping, e.g. as a cold-heading part. The outside periphery of the substantially disc-shaped retaining collar 2 is configured as a calking punch so that it is press-fitted with its undercut extending along the periphery with the ready-made valve housing 1 in a stepped accommodating bore of a block-shaped valve carrier 4. The soft material of the valve carrier is displaced during the pressing operation into the undercut for fastening and sealing purposes. Above the retaining collar 2, the open end portion of the sleeve-shaped valve housing 1 is closed by means of a plug 14 additionally assuming the function of a magnet core. Likewise plug 14 is a low-cost cold-heading part that is manufactured with a sufficient rate of precision and laser-welded at its outside periphery with the valve housing 1. Disposed below the plug 14 is a magnet armature 15 being manufactured equally very inexpensively from a round or many-sided profile by means of cold-heading or extruding operations, respectively. Magnet armature 15, under the effect of a compression spring 16, closes in the valve's basic position a first valve passage 5 arranged in a second valve closure member 8 by means of the first valve member 7 that is fitted to the tappet-shaped extension of the magnet armature 15. To this end, the first valve closure member 7 is expediently fitted as a hemisphere at the tappet portion that is attached in a bore of the magnet armature 15 by means of self-calking. The second valve closure member 8 is substantially designed as a bowl-shaped deepdrawn part acted upon in the valve's closing position of the first valve closure member 7 by the effect of a spring 17.

However, due to the effect of the compression spring 16 interposed between the plug 14 and the magnet armature 15, the bottom of the bowl-shaped second valve closure member 8 acting as a valve closure means remains in the valve's basic position shown in the drawings on a second valve passage 6 provided in the bottom end of the valve housing 1. The cross-section of said valve passage that can be opened in response to the hydraulic differential pressure is considerably larger than the opening cross-section at the first valve passage 5 that can be opened electromagnetically.

Spring 17 is supported at an edge of the second valve closure member 8 configured as a sleeve-type piston and being horizontally penetrated by punched transverse bores 22.

To accommodate and seal the valve housing 1 in the bore step 11, the valve housing 1 is decreased in diameter in the area of the bore step 11 and equipped with a sealing ring 10 so that between the valve housing 1 and the bore step 11, leakage flow is prevented between the pressure fluid inlet 13 opening horizontally into the valve housing 1 and the pressure fluid outlet 19 arranged below the valve housing 1. The pressure fluid inlet 13, which is basically illustrated as a transverse channel in the valve carrier 4, is continued through the annular filter 12 disposed in the hollow space 20 of the valve carrier 4 to the punched transverse bore 21 in the valve housing 1 so that pressure fluid on the inlet side is applied directly to the second valve closure member 8, whose transverse bores 22 arranged in the horizontal plane to the transverse bore 21 ensure a low-resistance flow route without any rerouting and, hence, leading directly to the first valve member 7.

In addition, the electromagnetic valve is characterized in that the spring 17 is arranged outside the flow route that can connect the pressure fluid inlet 13 to the pressure fluid outlet 19. For this purpose, stop 3 is inserted remote from the flow route into the valve housing 1, at which stop the end of spring 17 remote from the second valve closure member 8 is supported. Consequently, spring 17 is not arranged in the flow route but above the transverse bores 21, 22 at stop 3. Stop 3 is secured to a housing step 19 of the valve housing 1 to this end. Said housing step 19 is arranged above the transverse bore 21 extending through the valve housing 1. Stop 3 is designed as a sleeve bowl widely opened in the bowl bottom and having an opening in which the second valve closure member 8 is guided and centered in the direction of the valve seat member 27. The one end of spring 17 is supported on the bowl bottom of stop 3. The bowl edge remote from the bowl bottom is angled off towards the inside wall of the valve housing 1. The result is that an annular chamber 25 accommodating spring 17 is positioned between the outside periphery of the sleeve bowl and the inside wall of the sleeve-shaped valve housing 1 and constitutes a permanent pressure fluid communication between the pressure fluid inlet 13 and a magnet armature chamber 26 by way of pressure compensating openings 18 arranged in the valve housing 1 and at the periphery of the sleeve bowl. Stop 3 and valve sleeve 1 consist of a deepdrawn thin sheet wherein the pressure compensating openings 18 are punched or impressed. Especially small valve parts that can be manufactured at low cost and with precision are achieved thereby.

The one-part valve housing 1 is designed as a stepped, thin-walled drawn sleeve whose open end remote from the second valve passage 6 is closed by a plug 14 effective as a magnet core and being designed as a cold-heading or extruded part allowing low-cost and precise manufacture. For the mechanical relief of the valve housing 1, the second valve passage 6 is provided in a disc-shaped or sleeve-shaped valve seat member 27 which is retained in a snug fit on the inside wall of the valve housing 1. The valve seat member 27 is composed of a wear-resistant metal. Its total height is chosen such that the second valve closure member 8 with its diametral transverse bores 21 rests at the level of the diametral transverse bores 22 of the valve housing 1, irrespective of whether the valve closure member 8, being in its closing position according to the drawing, closes the large second valve passage 6 or is lifted therefrom. Therefore, the two transverse bores 22 in the valve housing 1 are increased in their diameter compared to the passages of the transverse bores 21 positioned in the second valve closure member 8 at least by the stroke of the second valve closure member 8 so that the transverse bores 21 are always overlapping the transverse bores 22 even in the hydraulically initiated open position of the second valve closure member 8 for the purpose of a flow routing that is without any deviation and has a low resistance to the greatest degree possible.

The second valve closure member 8 is configured as a sleeve bowl whose bowl bottom accommodates the first valve passage 5 cooperating with the second valve closure member 7. Close to the bowl bottom, transverse bores 22 penetrate the peripheral surface of the sleeve bowl and are positioned in the horizontal plane of the transverse bore 21 to provide a flow route that is free from rerouting, if possible. Opposite to the bowl bottom, an edge is provided at the sleeve bowl that is angled-off in the direction of the sleeve-shaped stop 3 and on which the second end of spring 17 remote from stop 3 is supported. Designing the stop 3 as a sleeve portion radially spaced from the inside wall of the valve housing 1 includes the advantage that the forces that act from the retaining collar 2 on the valve sleeve 1 during the press fit operation of the electromagnetic valve are accommodated by the annular chamber 25 in the case of a deformation of the valve housing 1 and do not act on the second valve closure member 8. This prevents the second valve closure member 8 from being damaged and jammed, even if relatively significant tolerance variations occur. The sleeve bowl is of light weight, small and inexpensive, and is manufactured preferably by deepdrawing from a thin sheet.

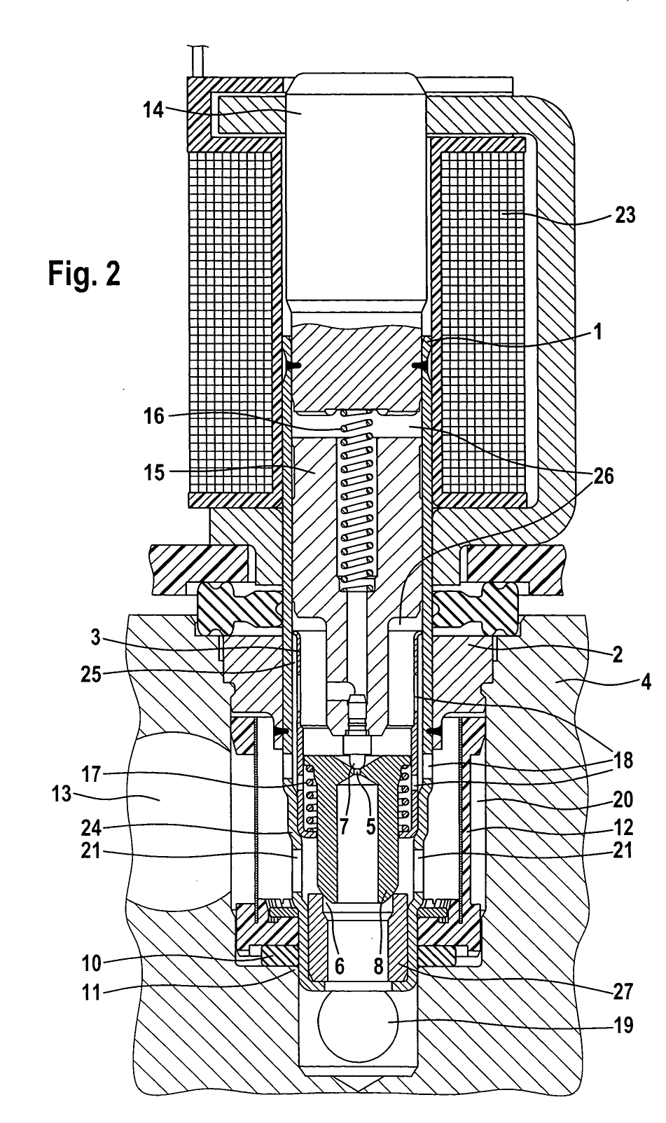

Different from FIG. 1, FIG. 2 discloses another suitable design of some component parts. The electromagnetic valve according to FIG. 2 differs basically from the valve construction according to FIG. 1 by the second valve closure member 8 and the valve seat member 27 being configured as solid turned parts and/or cold-heading parts. FIG. 2 shows the second valve closure member 8 as a slim piston part that is conically turned at its bottom end and manufactured inexpensively from free-cutting steel. Said conical end normally bears against the conical sealing seat of the hollow-cylindrical valve seat member 27 which, when required, exactly as the valve closure member 8 can be furnished with a surface hardening in the area of the sealing surfaces. Accommodation of the tappet portion within the second valve closure member 8 (cf. FIG. 1) is deliberately omitted in the design of the electromagnetic valve according to FIG. 2 because this would necessitate an unnecessary quantity of metal removed for manufacturing the valve closure member 8.

Even if not all the features shown in FIG. 2 have been explicitly described in the previous paragraph, they correspond to the features explained in FIG. 1.

1-13. (canceled)

14. Electromagnetic valve, in particular for slip-controlled motor vehicle brake systems, comprising:
a first and a second valve closure member arranged in a valve housing and being able, in a coaxial arrangement in the valve housing, to open or close a first and a second valve passage, including a pressure fluid inlet and a pressure fluid outlet opening into the valve housing, with the first valve closure member being able to open or close the first valve passage positioned in the second valve closure member in response to the electromagnetic excitation of a valve coil, and with the second valve closure member opening the second valve passage under the influence of a spring exclusively in the open position of the first valve passage so that pressure fluid prevailing in the pressure fluid inlet propagates to the pressure fluid outlet along a flow route inside the valve housing in which the first and the second valve passage are positioned, wherein the spring is placed outside the flow route, to what end a stop is arranged in the valve housing remote from the flow route, and the end of spring remote from the second valve closure member being supported on said stop.

15. Electromagnetic valve as claimed in claim 14,
wherein the stop is arranged above a transverse bore opening into the valve housing and being connected to the pressure fluid inlet.

16. Electromagnetic valve as claimed in claim 15,
wherein the stop is provided at a housing step of the valve housing that is positioned above the transverse bore and whose inside diameter is adapted to the outside diameter of the stop.

17. Electromagnetic valve as claimed in claim 15,
wherein the stop is configured as a sleeve-shaped bowl in whose interior the one end of the spring is supported on a bowl bottom, which is positioned with its outside surface on a housing step disposed above the transverse bore in the valve housing.

18. Electromagnetic valve as claimed in claim 17,
wherein the stop has a bowl edge remote from the bowl bottom that is angled off in a radial outward direction and bears against the inside wall of the valve housing.

19. Electromagnetic valve as claimed in claim 17,
wherein an annular chamber is provided between the outside periphery of the sleeve-shaped bowl and the inside wall of the sleeve-shaped valve housing, establishing a permanent pressure fluid connection between the pressure fluid inlet and a magnet armature chamber through pressure compensating openings arranged in the valve housing and in the sleeve-shaped bowl.

20. Electromagnetic valve as claimed in claim 19,
wherein the spring extends vertically inside the annular chamber.

21. Electromagnetic valve as claimed in claim 17,
wherein the one end of spring remote from the bowl bottom bears against a bead of the piston-shaped second valve closure member extending through an opening in the bowl bottom towards a valve seat member that is press-fitted below the transverse bore into the valve housing.

22. Electromagnetic valve as claimed in claim 21,
wherein the second valve closure member is manufactured as a turned part from free-cutting steel.

23. Electromagnetic valve as claimed in claim 17,
wherein the stop and the valve sleeve consist of a deepdrawn thin sheet, and that the pressure compensating openings and the transverse bore are punched or impressed therein.

24. Electromagnetic valve as claimed in claim 14,
wherein the valve housing has a one-part design, and its open sleeve end remote from the second valve passage is closed by a plug acting as a magnet core and being configured as a cold-heading or extruded part.

25. Electromagnetic valve as claimed in claim 14,
wherein the second valve passage is provided in a disc-shaped or sleeve-shaped valve seat member being configured as a turned part or cold-heading part in conformity with the demands of automation.

26. Electromagnetic valve as claimed in claim 14,
wherein the second valve closure member is designed as a sleeve bowl made in a deepdrawing operation, the bowl bottom accommodating the first valve passage cooperating with the first valve closure member, and in that close to the bowl bottom the peripheral surface of the second valve closure member is penetrated by transverse bores which are positioned in the horizontal plane of a transverse bore connected to the pressure fluid inlet to form a flow route with least possible rerouting, said transverse bore extending through the valve housing in a horizontal direction.
